(19) United States
(12) Patent Application Publication
(10) Pub. No.: US 2005/0066049 A1
(43) Pub. Date: Mar. 24, 2005

(54) Extendable local network associated with a building

(75) Inventors: Laurent Clevy, Chartres (FR); Patrick Fontaine, Paris (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/942,998

(22) Filed: Sep. 17, 2004

(30) Foreign Application Priority Data
Sep. 19, 2003 (FR) 03 11 008

(51) Int. Cl. G06F 15/16

(52) U.S. Cl. 709/231; 709/229

(57) ABSTRACT

A gateway (G) between an Internet network (N) and a local network (N_{L}) associated with a building constituted by a plurality of private premises and at least one common area; the common area and at least some of the private premises having multimedia terminals (T₁, T₂, T₃, T_{P}, . . . ) connected to the local network (N_{L}). The gateway is characterized in that it comprises execution means for executing extended services downloaded from a server (S) accessible via said Internet network (N).

The present invention relates to systems giving access to a building. More particularly, it relates to a local network associated with a building.

A building possesses a set of private premises, which may be residential premises, office premises, etc., and at least one common area situated in front of the access door to the building.

Typically, a system giving access to a building comprises a terminal situated in front of the building access door, i.e. in the common area, and one terminal per private premises. These terminals are interconnected by a local network, enabling communication to take place between a terminal in a private premise and the terminal in the common area.

By means of communication as set up in this way, the user of the terminal in a private premises can decide whether or not to open the access door to the building.

Nevertheless, such a system suffers from several drawbacks. In particular, the services offered by such a system are limited to the public terminal calling a private terminal, and establishing communication therewith. Unfortunately, it often happens that nobody is present in the premises when someone seeks to make a visit. No contact is then possible, and in certain buildings, there is no way for the visitor even to leave a message for the occupiers of the premises to be visited.

The object of the invention is to maximize the chance of contact being established between visitors and the people they are visiting.

Another object of the invention is to propose a local network associated with a building in which the network is extendable, thus enabling new services to added or existing services to be modified.

To do this, in a first aspect, the invention provides a gateway between an Internet network and a local network associated with a building that is constituted by a plurality of private premises and at least one common area. The common area and at least some of said private premises are equipped with multimedia terminals connected to the local network. The gateway is characterized in that it comprises execution means for executing extended services downloaded from a server that is accessible via the Internet network.

In an embodiment, the gateway further comprises independent services permanently installed in the gateway, and executable by the execution means.

The gateway may also have a user database, enabling (independent or extended) services to be triggered or put into operation by a user of one of the terminals.

In an embodiment, one of these services may be designed:
to detect a call to a multimedia terminal in a private premise from the multimedia terminal in the public area; and
to transfer the call to a device that is ascertained by the user data, and where appropriate to transfer the multimedia stream associated with said call.

The device in question may be a multimedia terminal in a private premises distinct from the premises having the called multimedia terminal. It may also be a device that is accessible via said Internet network.

A service may also be provided to ascertain an identifier of the user of the multimedia terminal in the common area, and to trigger an action as a function of the user data.

In a particular embodiment of the invention, the gateway possesses means for controlling one or more access doors to the building, possibly via the multimedia terminal in the common area. The services are then capable of ordering the opening of the access door(s) in co-operation with said control means.

A service may be provided to ascertain a code provided by the user of the multimedia terminal in the common area and for ordering the access door(s) to be opened, providing the access code is valid, said valid code being of validity that is limited in time.

The invention also provides a server for operating in co-operation with the gateway of the invention. The server is characterized in that it comprises an extended services base and means for downloading one or more extended services contained in said base to the gateway, on request therefrom.

In an embodiment, the server may further possess a user database synchronized with the user database contained in the gateway.

The server may also have a user interface that is accessible via the Internet network, enabling the user data to be consulted or modified. The user interface may be implemented by a server of the hypertext transfer protocol (HTTP) type.

The server may also be designed to have means for acting via said user interface to request a valid code enabling the access door(s) to be opened.

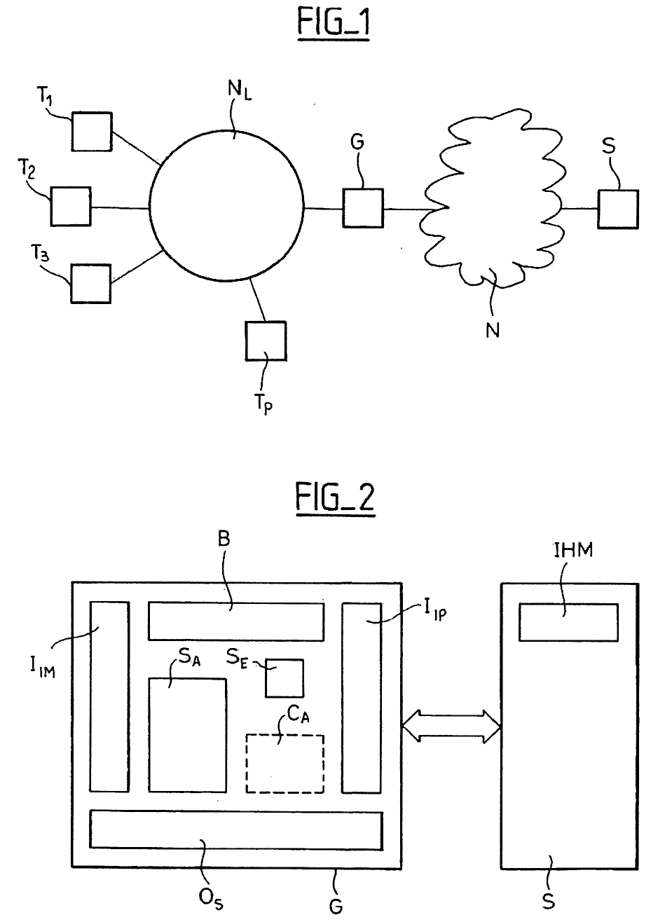

FIG. 1 shows the general architecture of the local network of the invention together with the context in which it is implemented.

FIG. 2 is a diagram of the gateway of the invention, and of its interactions with the server.

FIG. 1 shows the local network N_{L} associated with a building. This local network has private multimedia terminals T₁, T₂, T₃, . . . , connected thereto which are located in private premises, and also at least one terminal T_{P} located in a common area.

Such a local network may be implemented using various technologies. It may be an Internet protocol (IP) network, an Ethernet™ network, or a network carried over the electricity network, etc.

The local network N_{L} is also connected to a gateway G.

The gateway G is connected to a network N which is also connected to a server S. The network N may in particular be a network of the Internet type, i.e. a data network based on a TCP/IP protocol stack and connected to the other Internet networks in the world.

The gateway G can download extended services from the server S via the network N. It possesses means for executing these services, which are software modules.

FIG. 2 is a diagram of the internal functional architecture of the gateway G.

It has an operating system (OS) enabling the services proposed by the gateway to be executed.

The services may be extended services SE downloaded from the server S, or they may be independent services SA that are permanently installed in the gateway. These independent services are optional and allow the gateway G to present a degree of independence relative to the server S, and in particular to continue to provide certain services, the most usual services, in the event of an accidental disconnection from the server S.

In an embodiment, the independent services S_{A} can be executed directly by the operating system OS, while an adaptation layer C_{A} enables the extended services S_{E} to be executed. In another embodiment, all or some of the independent services S_{A} can be executed by the adaptation layer C_{A}.

For example, the adaptation layer may be a Java™ virtual machine, and the extended services S_{E} and possibly also some of the independent services S_{A} may be Java applets.

In another embodiment, the extended services S_{E} and possibly also some of the independent services S_{A} are remote procedure call (RPC) software modules, as defined by request for comments (RFC) 1050 of the Internet Engineering Task Force (IETF).

The gateway G also has interfaces I_{IM} and I_{IP} respectively with the local network N_{L} associated with the building, and with the Internet network N.

The gateway G may also include a user database B. This database B enables services S_{E} and S_{A} to be triggered and/or operated. In particular, it can contain information concerning the conditions under which services may be triggered.

In an embodiment of the invention, the data stored in the user database B is synchronized with a database contained in the server S. In other words, the server S has a copy of the user database B or of a portion thereof, and each time a modification is made in the database B or in its copy, that modification is automatically transferred into the copy of the database. This synchronization may be carried out via the interface I_{IP} with the Internet network N.

It is even possible to provide the server S with a user interface IHM enabling the user data contained in the copy of the database to be consulted or modified, or at least the data contained in a portion of the copy. Preferably, this user interface complies with the HTTP protocol, with the I-mode™ protocol from the supplier DoCoMo, or with the wireless application protocol (WAP), etc.

It is then possible for a user of a multimedia terminal to consult or modify the configuration of the services in place, even when the user is away from the building. All the user requires is access to the Internet network N via a communications terminal.

Based on such an architecture, the gateway of the invention can provide various extended services on request. It is also possible for the operator of the server S to add new extended services, which are automatically downloaded to the gateway G, e.g. when a multimedia terminal requests them.

By means of the invention, it is also possible for the operator to provide various subscriptions to sets of services: for example the operator may provide only “basic” extended services at a first rate, and additional extended services at a second rate that is higher than the first.

In an embodiment of the invention, the gateway has means for controlling one or more access doors to the building. These control means may optionally operate via the multimedia terminal in the common area.

The extended services S_{E} or the independent services S_{A} may be adapted to order said access door(s) to be opened in co-operation with said control means.

An example of a service provided by the gateway may be a call transfer service. This service may be an independent service or an extended service, i.e. a service downloaded from the server S.

The service is used to detect a call being made to a multimedia terminal in one of the private premises from the multimedia terminal in said public premises.

Either on all occasions or else after some configurable number of rings, the service can act to transfer the call to a given device, and where appropriate it can also transfer the multimedia stream associated with the call.

The device in question can be any terminal, but it is preferably a multimedia terminal capable of handling the multimedia streams associated with the call, i.e., typically, a video stream and an audio stream.

The address of said device, the number of rings, and other parameters can be stored in the user database B. This data can be put into the database by the user from the multimedia terminal in the corresponding private premises.

Because of the synchronization with the database contained in the server S, the user can also cause data to be stored or modified in the server S via the user interface IHM.

By means of such a server, a visitor can be put into contact with the person being visited, even when that person is absent: the two people can then agree on some other rendezvous or can communicate the information they needed to communicate.

In an embodiment of this service, the device to which the call is transferred is a multimedia terminal in premises distinct from the premises having the called multimedia terminal.

Such a service is particularly useful when a person residing in a first premises is visiting a second premises. In spite of being away from home, that person can request calls to be transferred to the multimedia terminal of the visited premises. Such a visitor can thus benefit from the same functions as are available at home, and in particular can cause the access door to be opened.

However, the invention can be used for transferring to any type of multimedia terminal, including multimedia terminals that are accessible via the Internet network N.

Another service provided by the gateway G may be to trigger an action as a function of a visitor identifier.

The service is intended firstly to ascertain an identifier for the user of the multimedia terminal in the common area. By way of example, the identifier might be a code keyed in by the user via a keypad, or a touch-sensitive screen placed on the multimedia terminal. It may also be the name of the user, as input in the form of an alphanumeric string. Other identification means could also be provided.

As a function of the code, and as a function of the premises being called, some particular action may be triggered by the service.

For example, a person residing in a particular premises may configure the service to deliver a prerecorded message to certain visitors in that person's absence: thus, the identifiers of those visitors are associated with the action of producing the message.

As explained above, for the call transfer service, this association, the content of the message, and other parameters can be stored by the resident using the resident's own multimedia terminal or the user interface of the server.

The service may also be designed to associate the identifiers of certain visitors with the action of transferring their calls. It is thus possible to transfer calls only from certain specifically-identified people.

Another service may be a service of opening the access door(s) by means of a temporary code.

The service begins by ascertaining a code as supplied by the user of the multimedia terminal in the common area. The code may be input by means of a keypad, a touch-sensitive screen, or by any other means.

Thereafter, the service can cause the access door(s) to be opened, providing the code is a valid access code, where valid codes have validity that is limited in time.

In another embodiment of the service, the server S has means for enabling requests to be made for such valid codes via the user interface IHM.

It is thus possible for a visitor from an outside organization to request a temporary code (e.g. valid for one day only) enabling that visitor to open the access door(s) of the building. Such a visitor may be an employee of the electricity, water, gas, etc. utility company that supplies the building, where such an employee might need to verify equipment or read meters.

1. A gateway (G) between an Internet network (N) and a local network (N_{L}) associated with a building constituted by a plurality of private premises and at least one common area, said common area and at least some of said private premises having multimedia terminals (T₁, T₂, T₃, T_{P}, . . . ) connected to said local network (N_{L}), said gateway being characterized in that it comprises execution means for executing extended services downloaded from a server (S) accessible via said Internet network (N).

2. A gateway according to claim 1, further comprising independent services, permanently installed in said gateway, and executable by said execution means.

3. A gateway according to claim 1, further comprising a user database, enabling said services to be triggered or operated by a user of one of said terminals.

4. A gateway according to claim 3, in which at least one of said services is designed:
to detect a call to a multimedia terminal in a private premises from the multimedia terminal in said common area; and
to transfer said call to a device ascertained by said user data, and where appropriate also to transfer the multimedia streams associated with said call.

5. A gateway according to claim 4, in which said device is a multimedia terminal in a private premises distinct from the premises having the called multimedia terminal.

6. A gateway according to claim 4, in which said device is accessible via said Internet network.

7. A gateway according to claim 3, in which at least one of said services is designed to ascertain an identifier of the user of said multimedia terminal in said common area, and to trigger an action as a function of said user data.

8. A gateway according to claim 1 or claim 4, possessing control means for controlling one or more access doors of said building, possibly via said multimedia terminal in said common area, said services being capable of causing said access door(s) to be opened in co-operation with said control means.

9. A gateway according to claim 4, in which at least one of said services is designed to ascertain a code supplied by the user of said multimedia terminal in said common area and to cause said access door(s) to open if said code is a valid access code, said valid code having validity that is limited in time.

10. A server for operating in co-operation with a gateway according to claim 1, said service being characterized in that it includes a base of extended services and means for downloading one or more extended services contained in said base to said gateway, on request therefrom.

11. A server according to claim 10, further including a user database synchronized with the user database contained in said gateway.

12. A server according to claim 11, further including a user interface that is accessible via said Internet network, the interface enabling said user data to be consulted or modified.

13. A server according to claim 12, in which said user interface is implemented by an HTTP type server.

14. A server according to claim 12, co-operating with a gateway in which at least one of said services is designed to ascertain a code supplied by the user of said multimedia terminal in said common area and to cause said access door(s) to open if said code is a valid access code, said valid code having validity that is limited in time, means being provided in the server to act via said user interface to request a valid code enabling said aces door(s) to be opened.
